(19) United States
(12) Patent Application Publication
(10) Pub. No.: US 2003/0126004 A1
(43) Pub. Date: Jul. 3, 2003

(54) Method and system for a graphical view of selectable work items

(75) Inventors: Wayne F. Miller, Cary, NC (US); Alan Tsu-I Yaung, San Jose, CA (US); Kenneth Carlin Nelson, Hollister, CA (US)

Correspondence Address: Paul D. Greeley, Esq., Ohlandt, Greeley, Ruggiero & Perle, L.L.P., One Landmark Square, 10th Floor, Stamford, CT, 06901-2682, US

(73) Assignee: INTERNATIONAL BUSINESS MACHINES CORPORATION, ARMONK, NY

(21) Appl. No.: 10/033,466

(22) Filed: Dec. 27, 2001

(51) Int. Cl. G06F 17/60

(52) U.S. Cl. 705/9

(57) ABSTRACT

The present invention pertains to a method, system and storage medium for providing a process view of at least one work item of a process, such as a process for accomplishing tasks of a business process. The method includes the steps of presenting a list view that provides the work item in a list format, selecting the work item from the list view; and providing the work item in the process view. The process view includes a graphical representation of the work item, and representations of relationship data of the work item relative to the process.

### BACKGROUND OF THE INVENTION

1. Field of the Invention

The present invention relates to a computer-implemented method and system for representing work processes, and in particular pertains to a method, system and article of manufacture for providing a graphical workflow view of selectable work items.

2. Description of the Related Art

Business process systems are implemented and managed in a variety of computer-implemented systems, either as stand-alone systems and programs or incorporated into certain aspects of a computer-implemented system/program. Examples of systems that incorporate features of a business process system include, but are not limited to, content management systems and enterprise (business) portal systems. These types of systems are typically deployed in environments wherein numerous users of the systems work in a collaborative effort to accomplish the business processes involved with, for example, managing and supporting the content of a web site, and managing and integrating applications on a business process level.

The proper and efficient execution of business processes within an organization, e.g., development or production of a process within a business organization, is very important and can have direct consequences on the success of the organization's operations. A business process includes a number of steps or tasks that are completed in order to execute the process. In a typical business setting, the responsibility of accomplishing the tasks of the process are distributed among a plurality of people. Each person assigned a task is responsible for some aspect of the task, the execution of which in turn ensures that the task is completed, hopefully, in a timely, efficient, and satisfactory manner.

The particular tasks of a process have work items associated therewith that include the details of the task. The work items are assigned to the person(s) responsible for executing the processes of the organization (i.e., the owner(s)). The owner of the work items is typically presented with a listing of the items for which they are responsible for reviewing, supervising, contributing to, editing, executing, etc. Given the collaborative structure of many of today's business processes and/or the dispersed nature of the persons responsible for accomplishing the tasks of the organization's processes, a listing of work items, (i.e., a textual presentation of the work items) fails to provide the contextual details to the work item owner. Contextual data, conveyed in a concise and convenient manner is advantageous in that it assists in increasing the work item owner's efficiency and accomplishment of their work items, thereby increasing the efficiency with which the process may be accomplished.

The present invention alleviates the problem of a lack of contextual data provided by a list presentation of one or more work items, particularly in computer-implemented systems.

### SUMMARY OF THE INVENTION

The present invention provides a graphical representation, that is, a process view of a work item of a process from a list view of the work item. Included in the graphical representation of the work item is detail data related to the work item and relationship data, including the relative relationship of the work item to other tasks and work items in the process. Accordingly, the present invention provides a graphical, contextual presentation of the work item.

The present invention relates to a system, storage medium, and a method for providing a process view of a work item of a process, such as a business process. The method includes the steps of presenting a list view that provides a textual (i.e., alpha-numeric) listing of the work item in a list format, selecting the work item from the list view, and providing the work item in the graphical process view. The process view includes a graphical representation of the work item, and representations of relationship data of the work item relative to the process. In aspects thereof, the present invention includes the capability to obtain detailed data related to the work item and to customize the process view.

The above and other objects, advantages, and benefits of the present invention will be understood by reference to the following description and drawings.

### BRIEF DESCRIPTION OF THE DRAWINGS

FIG. 1 is a depiction of an environment and system applicable for implementing the present invention;

FIG. 2 is an illustration of a process presented in a process view;

FIG. 3 is an exemplary textual list view of work items associated with a task of a process in accordance with the present invention; and

FIG. 4 is an exemplary process view invoked by a selection of a work item in accordance with the present invention.

### DETAILED DESCRIPTION OF THE INVENTION

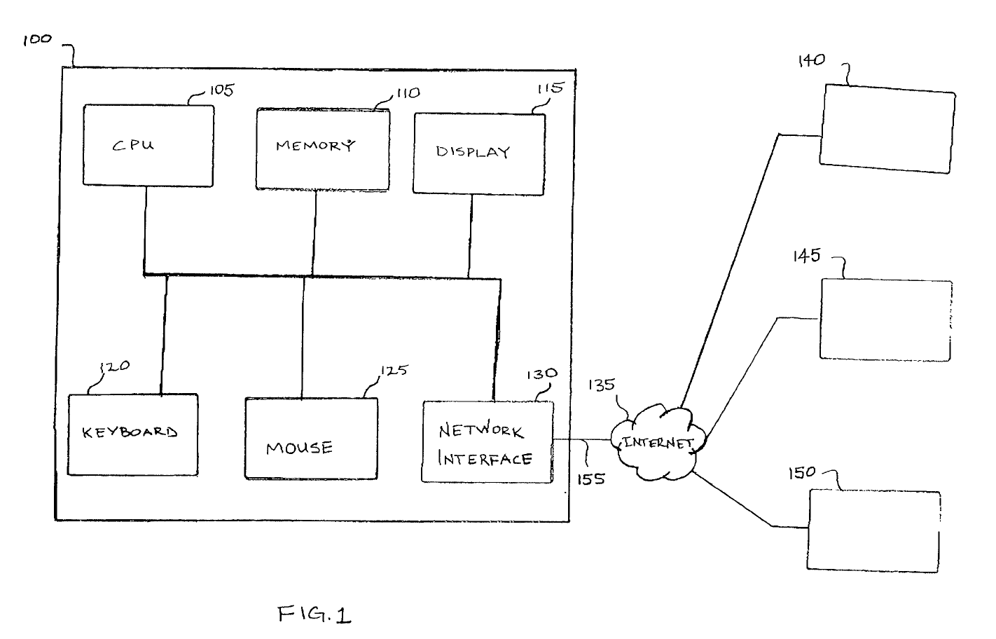

Referring to FIG. 1, there is illustrated an environment in which an embodiment of the present invention may be applied, including a computer 100. Computer 100 includes, for example, a CPU 105 for processing data and controlling the execution of instructions, memory 110 for storing data and program instructions, and display 115 for displaying textual and graphical representations thereon. Keyboard 120 and mouse 125 are user input devices that permit a user to enter data and provide user input to client network computer 100. It should be appreciated that other types of user input devices can be used without departing from the scope of the present teachings. Computer 100 includes a network interface 130 for transferring data to and from other data communication devices coupled to network 155.

In the example shown, computer 100 is coupled to the Internet 135 via network interface 130 and network 155. It should be appreciated that network 155 may be a LAN and/or WAN, wired or wireless. Communication with other data communication devices, such as, but not limited to, computers (140, 145) and database 150 is facilitated by the Internet 135. Exemplary computer 100 may be any computer having suitable data communications capability.

The environment depicted in FIG. 1 can be extended to encompass many of the situations in which today's business workers find themselves working. For example, business workers are often distributed in different locations within an organization yet work in a collaborative manner with others within and outside of the organization, such as colleagues, customers, vendors, and suppliers. Accordingly, the data communication devices used by the various workers are capable of communicating with each other via a variety of communication network environments, including but not limited to, the example of FIG. 1.

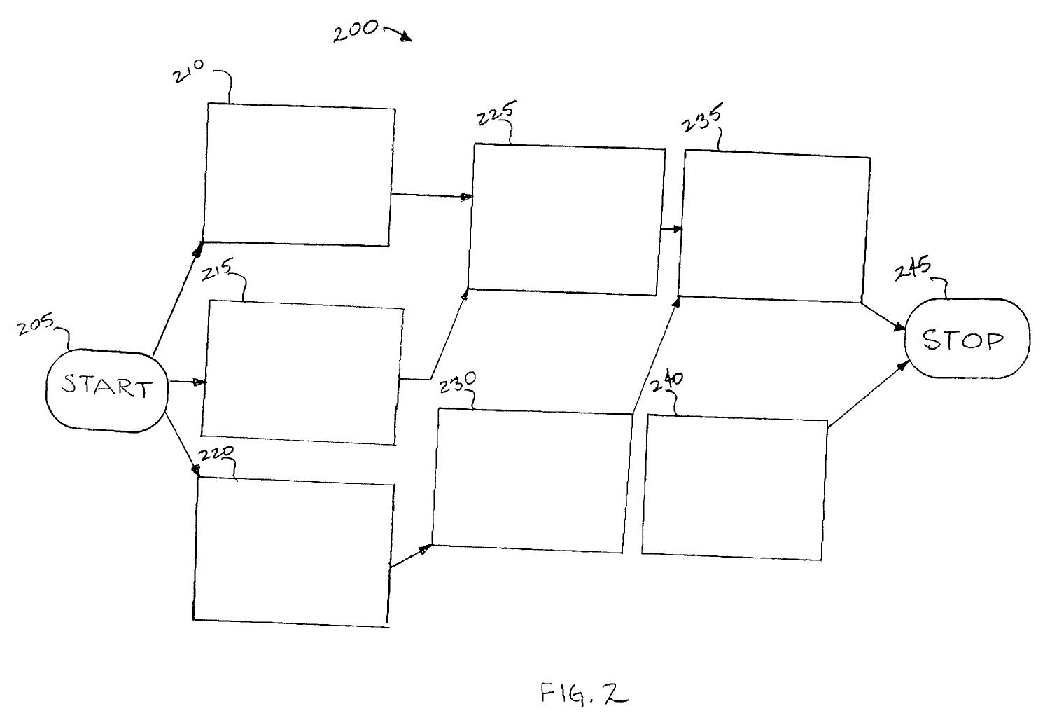

Referring now to FIG. 2, there is shown an exemplary presentation of a business process 200. Process 200 has a start 205 and an end 245. In between its start 205 and end 245, process 200 has a number of tasks, represented by nodes 210 through 240. The connectors (i.e., arrows) between the nodes of process 200 represent a relationship between the tasks comprising process 200. For example, in the process shown, the relationship between task 210 and 225 is such that task 210 is to be accomplished prior task 225. This relationship data is conveyed, in the present example, by the arrow originating at node 210 and terminating at node 225.

As used herein, a graphical representation of a process such as process 200 of FIG. 2, is referred to as a process view. Accordingly, a process view conveys the tasks of a process, as well as relationships among the tasks in a graphical representation. It should be appreciated that FIG. 2 is but one example of a process view and that the present invention encompasses process views of various implementations.

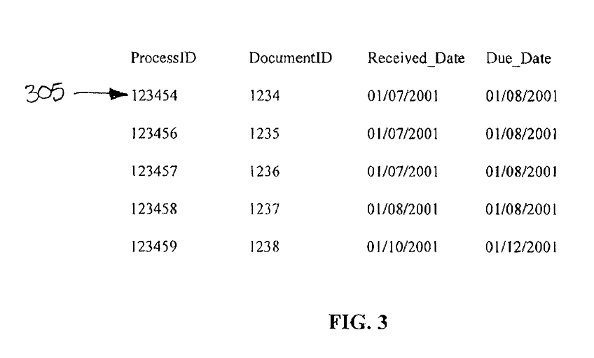

Associated with a task (e.g., node 210) of process 200 is a work item. The work item is a representation of a single instance of the process. Work items are presented in a list view 300, such as that illustrated in FIG. 3. As shown, textual (i.e., alpha-numeric) list view 300 provides a listing of four work items (i.e., the rows of list view 300). Work item 305, for example, is associated with ProcessID 123454, and a document having DocumentID 1234.

List views are commonly used to provide users of computer-implemented systems, including, but not limited to, process management systems, content management systems, and information portals with a listing of work items assigned to them for which the are responsible for reviewing, completing, approving, revising, etc. While list view 300 provides details concerning work item 305, such as ProcessID, DocumentID, Received_Date, and Due_Date, other details related to the process are not conveyed by list view 300. For example, the relationship of a work item (e.g., work item 305) to other tasks and associated work items in process 200 is not presented in list view 300.

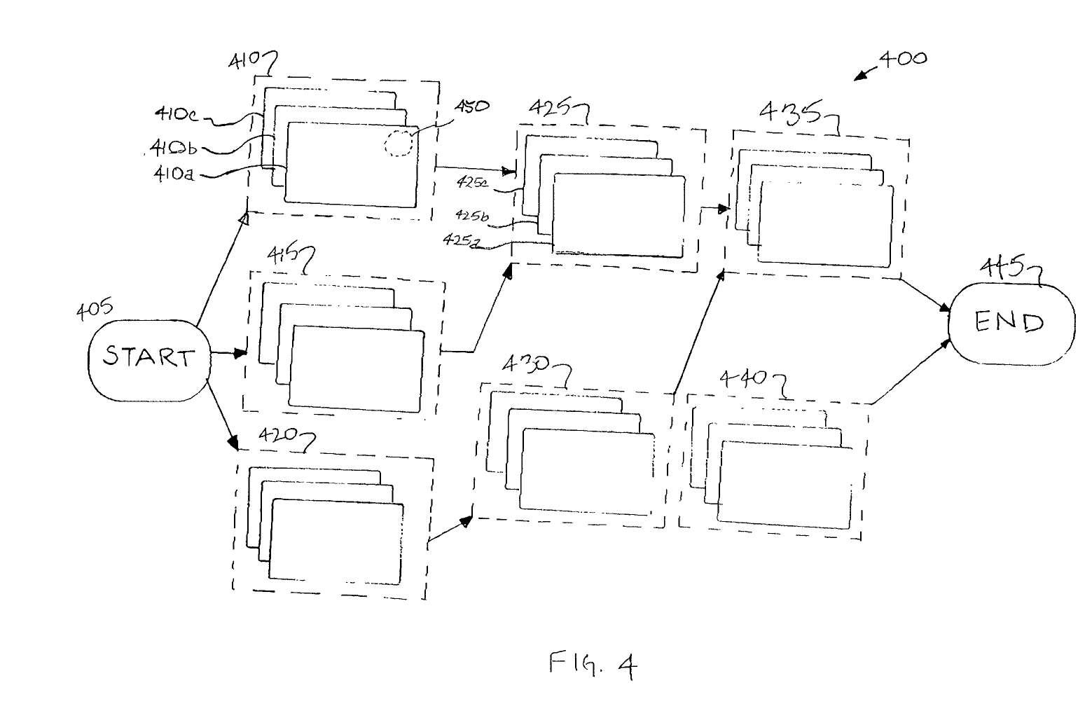

In an aspect of the present invention and in accordance therewith, a work item list view 300 is provided in a process-oriented process view, that is, in a graphical, process view representation of the work item, as shown in FIG. 4. In this manner, details related to a work item, as well as relationship data of the work item relative to the process that the work item is associated with is provided in a common presentation. Providing the work item in process view 400 provides a user with a perspective of the work item not conveyed by list view 300. The user assigned a work item is presented with details related to work item 410, such as, for example, the status of work item 410, and the relationship of work item 410 to other tasks of process 400 (e.g., tasks 425).

Regarding details related to a work item and presented in process view 400, the details can include, though are not limited to, the status of the work item (i.e., not yet started/in progress/completed), the owner(s) of the work item, and the number of work items associated with a task (i.e., node) of process 400. For example, the number of work items at nodes 410 and 425 number three in the example shown, 410a, 410b, 410c and 425a, 425b, 425c, respectively. Details such as the priority of work items associated with a task can also be conveyed by process view 400. For example, the work items of task 410 are prioritized from 410a (highest) to 410c (lowest), as illustrated by the relative locations of the work items. This data associated with the work items 410a-410c provides a user with insight into process 400.

In an aspect of the present invention, the status (i.e., not yet started/in progress/completed) of a work item can be presented to a user (i.e., a worker) using the present invention as implemented, for example, on system 100. An indication of the status of the work item can be represented by displaying the work item in a particular color. For example, a work item not yet started may be displayed as red, a work item in progress may be displayed as yellow, and a work item completed may be displayed as green.

In another aspect of the present invention, an icon, 450, can be used to represent details (i.e., characteristics) of work item 410a. For example, icon 450 can be presented in process view 400 in a portion of the graphical representation of work item 410 to indicate the status of work item 410a. It should be appreciated that any graphical icon may be used, whether animated or static, in accordance with the present invention.

As discussed above, many business processes entail the completion of various tasks by more than one person. Thus, the execution of a work item necessary to accomplish a task of a business process may involve a plurality of workers. Workers are typically assigned one or more tasks related to a business process for which they are responsible for accomplishing. The process defines the relationships between the tasks.

In another aspect of the present invention, a user can determine the amount of detail presented in a process view invoked from a list view. Referring back to FIG. 1, there is a database 150 coupled to system 100 by network 155, including Internet 135. Database 150 may be used to store data related to process 400 so that process view 400 preferably presents a current, updated graphical presentation of process view 400. In other words, in an embodiment thereof, the present invention provides a current (i.e., real time) process view of the work item (e.g., 410a), including relationship data related thereto. Database 150 may be queried in response to a user input for data related to work item 410a. For example, a user input device such as, but not limited to, keyboard 120 and mouse 125, can be used to selected work item 410a from process view 400. The selection of work item 410a from process view 400 may in turn invoke the execution of a program instruction set by CPU 105 that queries database 150 for additional, current details related to work item 410a. Process view 400 is then updated to reflect the current (i.e., real time) status of the requested details.

An example of additional details returned by a query of database 150 includes the user that completed the work item, when the work item was completed, whether the work item was completed on schedule, the owner of the work item (i.e., person the work item is assigned to), the process coordinator for the process being queried, etc. The particular, related work item detail (i.e., data) presented can be implemented on various levels of the process view, wherein the level of the process view presented to a user is selected by a user employing any suitable selection process (e.g., right/left click, double-click, drag and drop, etc.) using a user input device, such as, but again not limited to, devices 120 and 125. Thus, work item details (i.e., related data) may be accessed through multiple selections of a work item or combinations of selections.

It is of course within the scope of the present invention that the details, that is the data associated with a work item, can include types of data other than the data type delineated above. It should also be appreciated that database 150 may be a centralized database or a distributed database, either of which may (or may not) be included in system 100.

In another aspect of the present invention, the process view invoked by the selection of a work item in a list view by a user presents a process view wherein work items assigned to (i.e., owned) the user are highlighted. The process view effectively conveys work items assigned to the user by highlighting the work items. This aspect of the present invention facilitates in having the “right data” effectively and efficiently presented to the “right people”. In this manner, the user can readily ascertain from the process view which work items are assigned to them and exactly how those work items relate to the overall process. The particular manner in which the highlighting is implemented may vary, and can include using a variety of colors, icons and/or other annotations to indicate a work item belongs to the user. It is preferable that the format of the highlighting, notwithstanding its particular format, is customizable by the user.

In accordance with the present invention, it is preferable that the details, that is data associated with the work items and process, are dynamically linked (i.e., associated) such that a user can intuitively navigate between a process view of a process (e.g., 200) and a list view of a work item comprising that process (e.g., 300) and a process view invoked by the selection of a particular work item (e.g., 305) that includes details and relationship data related to the selected work item as discussed in detail herein. The specifics of the manner in which the data associated with the work item and process are linked can be accomplished in a variety of implementations, that should be understood and appreciated by those skilled in the art thereof. An important aspect, however, is that the data is linked to facilitate the realization of the present invention in accordance with the teachings herein.

The present invention may be implemented by a computer readable storage medium (e.g., a removable storage medium, a memory card or a hard disk, such as memory 110) having program instructions embodied therein for executing the methods of the present invention. The computer readable storage medium can be read and the program instructions executed by a processor such as CPU 105. Accordingly, providing a process view of a work item of a process can be accomplished by program instructions for presenting a list view of the work item; program instructions for selecting the work item from the list view; and program instructions for exhibiting the work item in a process view, wherein the process view includes a graphical representation of the work item, including relationship data of the work item relative to the process.

It will be apparent, however, that various variations and modifications may be made to the invention, with the attainment of some or all of the advantages of the invention as indicated in the claims appended hereto.

What is claimed is:

1. A method for providing a process view of a work item of a process, said method comprising the steps of:
presenting a list view, said list view comprising at least one said work item;
selecting said work item from said list view; and
exhibiting said work item in said process view, wherein said process view presents a graphical representation of said work item, and includes relationship data of said work item relative to said process.

2. The method of claim 1, wherein said step of presenting said list view comprises presenting said work item in a textual format.

3. The method of claim 1, wherein said step of exhibiting said work item in said process view comprises representing said work item as a node in said process view.

4. The method of claim 1, wherein said step of exhibiting said work item in said process view comprises the step of graphically representing a characteristic of said work item.

5. The method of claim 4, wherein a mode of said step of graphically representing is selected from a group consisting of: displaying said work item in a particular color, underlining said work item, and representing said work item as an icon.

6. The method of claim 4, comprising a step of selectively determining the mode of said step of graphically representing provided in said process view.

7. The method of claim 1, comprising a step of associating data with said work item.

8. The method of claim 7, wherein said data is selected from the group consisting of: an associated owner of said work item, an indication of when the work item was completed, an indication of whether the work item was completed on schedule, and an indication of a process coordinator for said process.

9. The method of claim 1, wherein said relationship data is selected from a group consisting of: an order, a state, and a relation of said work item to another work item in said process.

10. The method of claim 1, wherein said step of exhibiting said work item in said process view comprises associating said work item with a specified user.

11. A system for providing a process view of a work item of a process, said system comprising:
a display for presenting a list view thereon, said list view comprising at least one said work item;
an input device for selecting said work item from said list view; and
a processor for controlling, responsive to said input control, the exhibiting of said work item in said process view, wherein said process view is presented as a graphical representation of said work item, and includes relationship data of said work item relative to said process.

12. The system of claim 11, wherein said list view comprises said work item presented in a textual format.

13. The system of claim 11, wherein said process view comprises said work item represented as a node.

14. The system of claim 11, wherein a characteristic of said work item is exhibited as a graphical representation in said process view.

15. The system of claim 14, wherein a mode of said graphical representation of said characteristic is selected from a group consisting of: displaying said work item in a particular color, underlining said work item, and representing said work item as an icon.

16. The system of claim 14, wherein the mode of said graphical representation is selectively determined.

17. The system of claim 11, wherein said system comprises a capability for associating data with said work item.

18. The system of claim 17, wherein said data is selected from a group consisting of: an associated owner of said work item, an indication of when the work item was completed, an indication of whether the work item was completed on schedule, and an indication of a process coordinator for said process.

19. The system of claim 11, wherein said relationship data is selected from a group consisting of: an order, a state, and a relation of said work item to at least one other work item in said process.

20. The system of claim 19, wherein said process view comprises associating said work item with a specified user.

21. A storage medium having computer readable program instructions embodied therein for providing a process view of a work item of a process, said storage medium comprising:
program instructions for presenting a list view, said list view comprising at least one said work item;
program instructions for enabling selecting said work item from said list view; and
program instructions for exhibiting said work item in said process view, wherein said process view presents a graphical representation of said work item, and includes relationship data of said work item relative to said process.

22. The storage medium of claim 21, wherein said storage medium comprises program instructions for presenting said work item in a textual format.

23. The storage medium of claim 21, wherein said storage medium comprises program instructions for representing said work item as a node in said process view.

24. The storage medium of claim 21, wherein said storage medium comprises program instructions for graphically representing a characteristic of said work item.

25. The storage medium of claim 24, wherein said storage medium comprises program instructions for graphically representing said characteristic in a mode selected from a group consisting of: displaying said work item in a particular color, underlining said work item, and representing said work item as an icon.

26. The storage medium of claim 24, wherein said storage medium comprises program instructions for selectively determining the mode of graphically representing said process view.

27. The storage medium of claim 21, wherein said storage medium comprises program instructions for associating data with said work item.

28. The storage medium of claim 27, wherein said storage medium comprises program instructions for selecting said data from the group consisting of an associated owner of said work item, an indication of when the work item was completed, an indication of whether the work item was completed on schedule, and an indication of a process coordinator for said process.

29. The storage medium of claim 21, wherein said storage medium comprises program instructions for selecting said relationship data from a group consisting of: an order, a state, and a relation of said work item to at least one other work item in said process.
